(19) United States
(12) Patent Application Publication
(10) Pub. No.: US 2025/0123736 A1
(43) Pub. Date: Apr. 17, 2025

(54) SYSTEMS AND METHODS FOR CONTROLLING CONTENT GENERATION

(71) Applicant: SAP SE, Walldorf (DE)

(72) Inventors: Chengchao Zhu, San Jose, CA (US); S Joy Mountford, Mountain View, CA (US); So Yeon Kim, Brooklyn, NY (US); Zeshu Zhu, New York, NY (US); Henrik Miers, Potsdam (DE)

(21) Appl. No.: 18/794,276

(22) Filed: Aug. 5, 2024

Related U.S. Application Data
(60) Provisional application No. 63/590,138, filed on Oct. 13, 2023.

(51) Int. Cl. G06F 3/04847; G06F 40/40; G06T 11/00

(52) U.S. Cl. CPC G06F 3/04847; G06F 40/40; G06T 11/00; G06T 2200/24

(57) ABSTRACT

Some embodiments provide a program that receives natural language input containing words. The words are associated with configurable user interface controls in a user interface comprising visual representations. The program further receives user input modifying a configuration of the visual representations. In response, visual representations are mapped to numeric values, which are then mapped to predefined natural language terms to generate a prompt consumable by a large language machine learning model. The prompt is sent to the large language machine learning model to produce content aligning with the prompt. In response, the large language machine learning model produces one or more output images and the program populates the user interface with a preview corresponding to the one or more output images.

### CROSS REFERENCE TO RELATED APPLICATIONS

This Application claims priority to U.S. Provisional Patent Application Ser. No. 63/590,138, filed on Oct. 13, 2023, the entire contents of which are hereby incorporated herein by reference.

### BACKGROUND

The present disclosure relates generally to content generation and, in particular, to systems and methods for controlling content generation.

Content generation involves generating images, video, and other forms of content. The design process is typically very creative. However, modern content generation systems are digital platforms that must adhere to the constraints imposed by computers and computer programming. Content workers are typically skilled creative artisans, but such users often may not be skilled in the technical nuances of computer programming. Accordingly, there is a tension between the digital world of bits, bytes, and technical computer code and the creative world of skilled artisans. Indeed, the technicalities of computer code can often limit or constrain the creative process. Thus, it is a challenge to free creative artisans from the rigid structure of computer code and programming.

The present disclosure addresses these and other challenges and is directed to techniques for controlling content generation.

### BRIEF DESCRIPTION OF THE DRAWINGS

FIG. 1 illustrates a system for automating content creation by a machine learning model according to an embodiment.

FIG. 2 illustrates a method for automating content creation by a machine learning model according to an embodiment.

FIGS. 3A-3D illustrate examples of user interfaces for automating content creation by a machine learning model according to some embodiments.

FIGS. 4A-4B illustrate examples of alternative user interfaces for automating content creation by a machine learning model according to some embodiments.

FIG. 5 illustrates an example process for producing output by a machine learning model according to an embodiment.

FIG. 6 illustrates hardware of a special purpose computing system configured according to the present disclosure.

FIG. 7 illustrates a system for controlling content generation according to an embodiment.

FIGS. 8A-D illustrate example content generation controller techniques according to various embodiments.

FIG. 9 illustrates another content control technique where the elements are associated with curve to alter the attribute values.

FIG. 10 illustrates an example content generation method according to an embodiment.

### DETAILED DESCRIPTION

Described herein are techniques for controlling content creation. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Businesses and other enterprises often dedicate a large number of resources to develop vast amounts of references, content, and the like for different purposes. For example, a business may create training videos to teach new employees vital aspects of the job. However, the time and monetary cost necessary to produce high quality content may be untenable for some departments. The use of artificial intelligence for generative content creation can significantly reduce the time and cost to develop these materials. In the past, however, only scientists, engineers, and skilled researchers possessed the necessary expertise to develop and leverage artificial intelligence for generative content creation. Accordingly, there is a growing need for intuitive tools capable of controlling artificial intelligence to automate generative content creation, and thus, reduce the amount of resources needed to produce high quality content.

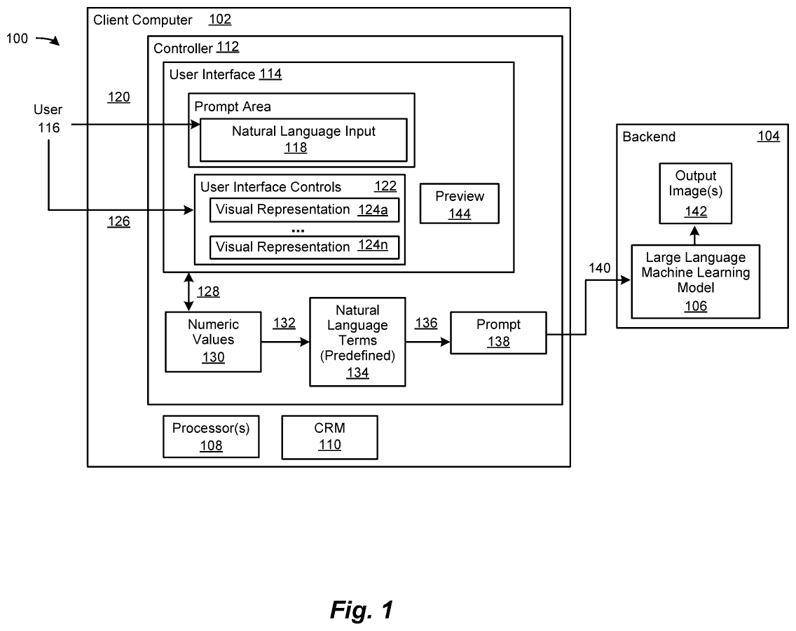

FIG. 1 illustrates a system for automating content creation by a machine learning model according to an embodiment. Computer system 100 may comprise a client computer 102 in communication with a backend 104. For example, backend 104 may be a cloud based server in communication with client computer 102 over a network (not shown). The backend 104 may host or otherwise provide access to a large language machine learning model 106. For example, the backend may expose an API endpoint for a large language machine learning model allowing client computer 102 to submit prompts to large language machine learning model 106 and receive responses based on the submissions from the backend. Client computer 102 may comprise one or more processors 108 and a non-transitory computer-readable medium (CRM) 110. Client computer 102 may execute controller 112 as a software module that provides user interface 114 on client computer 102, processes interactions with user interface 114 incoming from a user 116, and manages communications with backend 104.

User interaction may come from users manipulating the user interface for the purposes of utilizing a large language machine learning model to automatically generate content. For instance, as seen in FIG. 1, a natural language input 118 may be received 120 in user interface 114 provided by controller 112. Natural language input 118 may comprise a plurality of words entered by the user. For example, natural language input 118 may be received from the user typing the plurality of words into a prompt area of user interface 114 so that the natural language input 118 appears in this prompt area as the user is entering the plurality of words.

The user may confirm submission of the natural language input 118 via the user interface and, upon submitting, controller 112 populates user interface 114 with a plurality of user interface controls 122. Specifically, the plurality of words in natural language input 118 are associated with visual representations 124a-124n. In a particular example, the submitted natural language input contains the words “Dog and Cat.” In response to the submission, the system populates the user interface controls with a total of three visual representations (e.g. visual representations 124a, 124b, and 124n) each having a name that appears in the user interface controls to visually couple the individual visual representations with corresponding words of the submitted input. A first of these visual representations (e.g. visual representation 124a) is named “Dog.” A second visual representation (e.g. visual representation 124b) is named “and.” A third visual representation (e.g. visual representation 124n) is named “Cat.” As such, the system is configured to process interaction with the visual representation named “Dog” as a manipulation of the corresponding word “Dog” in the submitted input. Similarly, the word “Cat” is coupled to the second visual representation, as indicated by the name of the third visual representation appearing in the user interface controls. Accordingly, changes to the word “Cat” of the natural language input are received as changes to a configuration of the visual representation named “Cat.”

Visual representations 124a-124n are configurable in the user interface. As one example, visual representation 124a may be configured independently from the remaining visual representations (e.g. 124n) in order to control subsequent processing of the plurality of words by controller 112.

Features and advantages of such configurable visual representations include providing users flexible control over the subsequent processing of each word of the natural language input. This subsequent processing is seen in FIG. 1, where user input modifying a configuration of the visual representations is received 126 in user interface 114.

In response to receiving 126 the user input, controller 112 maps 128 the visual representations to a first set of numeric values 130. In some embodiments, each value of the first set of numeric values 130 is based on the configuration of the visual representations. Changes to the configuration of the visual representations change corresponding numeric values. As such, subsequent processing of each word in the natural language input responds to changes in numeric values based on the modifications to the visual representations 124a-124n. Features and advantages of this approach include providing data control and data manipulation for automatic content generation by large language machine learning model(s) through an interactive visual user interface, thus circumventing the need to write and maintain computer programming code for automatic content generation using such machine learning models. Consequently, the amount of resources necessary for content creation is also significantly reduced.

Next, controller 112 maps 132 each numeric value of the first set of numeric values 130 to a first set of predefined natural language terms 134 and generates 136 a prompt 138 based on the first set of predefined natural language terms 134. In some embodiments, a prompt may be a set of words consumable by a large language machine learning model, instructing the large language model to generate content (e.g. video). In some embodiments, a prompt may be based on the natural language input provided by a user. As one example, one or more words of the plurality of words constituent to the natural language input may be included in the set of words for the prompt, in addition to terms of the set of predefined natural language terms included in the prompt.

After generating the prompt, controller 112 may then send 140 prompt 138 to large language machine learning model 106 residing on backend 104. In turn, large language machine learning model 106 produces one or more output images 142.

As stated above, client computer 102 may be in communication with backend 104. Accordingly, user interface 114 may include a preview 144 corresponding to the one or more output images 142, as is further discussed herein.

In some embodiments, the preview is representative of a plurality of images produced by the large language machine learning model, as discussed herein. Accordingly, one advantage of providing the preview is that a user may quickly experiment with different prompts to understand the capabilities of the large language machine learning model and instruct the model to generate updated content, or completely new content, with minimum downtime. In one example, a user interacts with user interface controls in a user interface to prompt a large language machine learning model to generate output images depicting dogs and cats fighting. A first batch of output images are generated by the model and a preview for the images is sent to the user interface. The user inspects the preview and concludes that the model generated the first batch of output images includes images of only dogs and cats of similar sizes fighting each other. However, in this example, the user wants dogs to appear larger than cats in the output images. Accordingly, using the same user interface and the same user interface controls that were previously used to generate the first batch of output images, the user supplies a second input modifying the configuration of the user interface controls such that dogs appear larger than cats in the output images. The system, in turn, provides an updated prompt to the model, as discussed herein. In response, the large language machine learning model generates a second batch of new output images. Then, the user interface is updated with a preview for the second batch of output images, each depicting very large dogs fighting smaller cats.

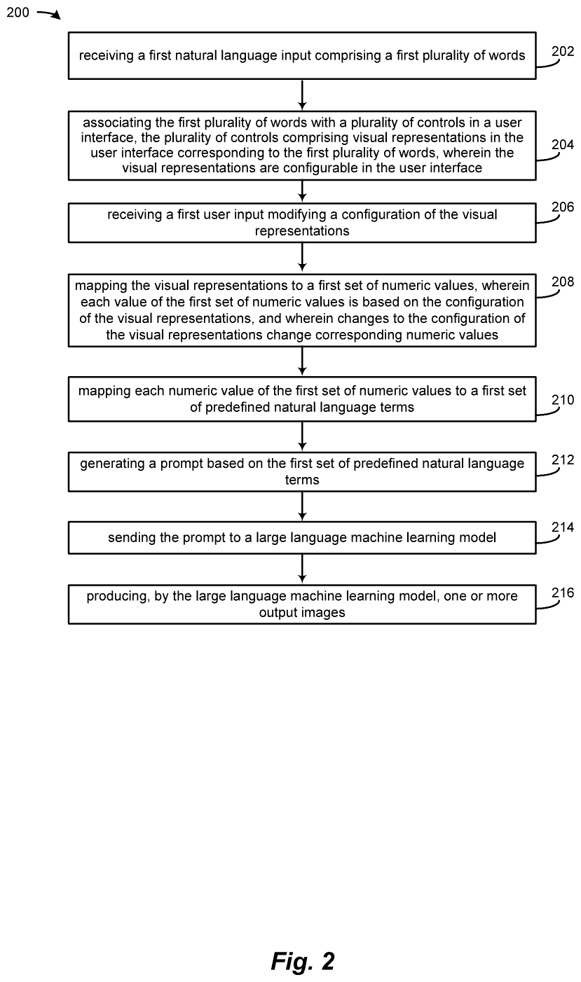

FIG. 2 illustrates a method for automating content creation by a machine learning model according to an embodiment. At 202, the method includes receiving a first natural language input comprising a plurality of words. At 204, the plurality of words is associated with a plurality of controls in a user interface. The plurality of controls may comprise visual representations in the user interface corresponding to the plurality of words. The visual representations are configurable in the user interface. At 206, the method includes receiving a first user input modifying a configuration of the visual representations. At 208, the visual representations are mapped to a first set of numeric values. Each value of the first set of numeric values is based on the configuration of the visual representations such that changes to the configuration of the visual representations change corresponding numeric values. At 210, each numeric value of the first set of numeric values are mapped to a first set of predefined natural language terms. In some embodiments, a plurality of natural language terms may be predefined and the first set of predefined natural language terms may be a subset of the totality of natural language terms. At 212, a prompt based on the first set of predefined natural language terms is generated. At 214, the prompt is sent to a large language machine learning model. At 216, the method includes producing, by the large language machine learning model, one or more output images.

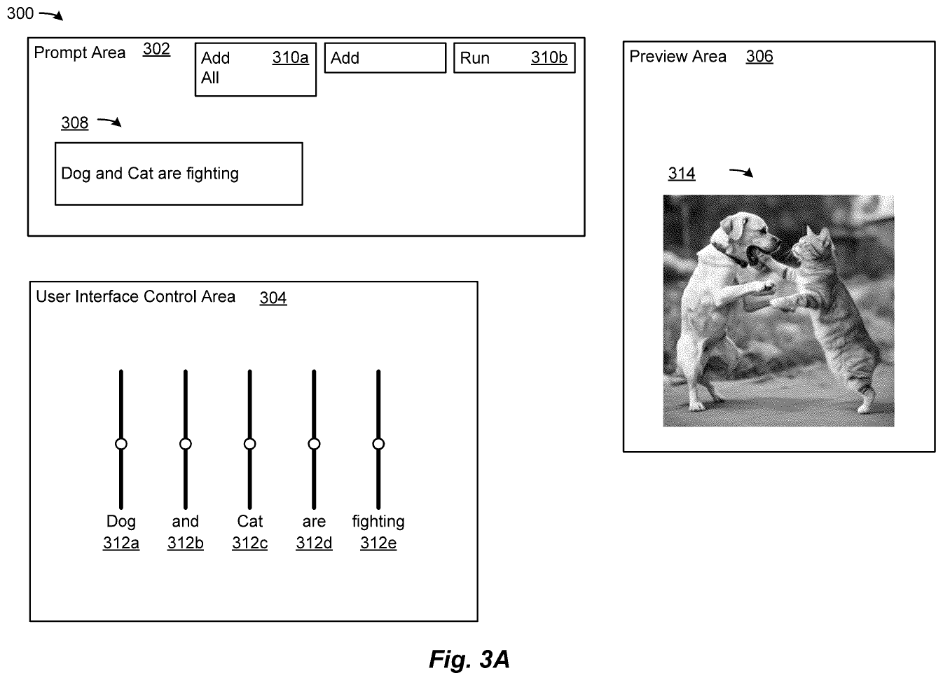

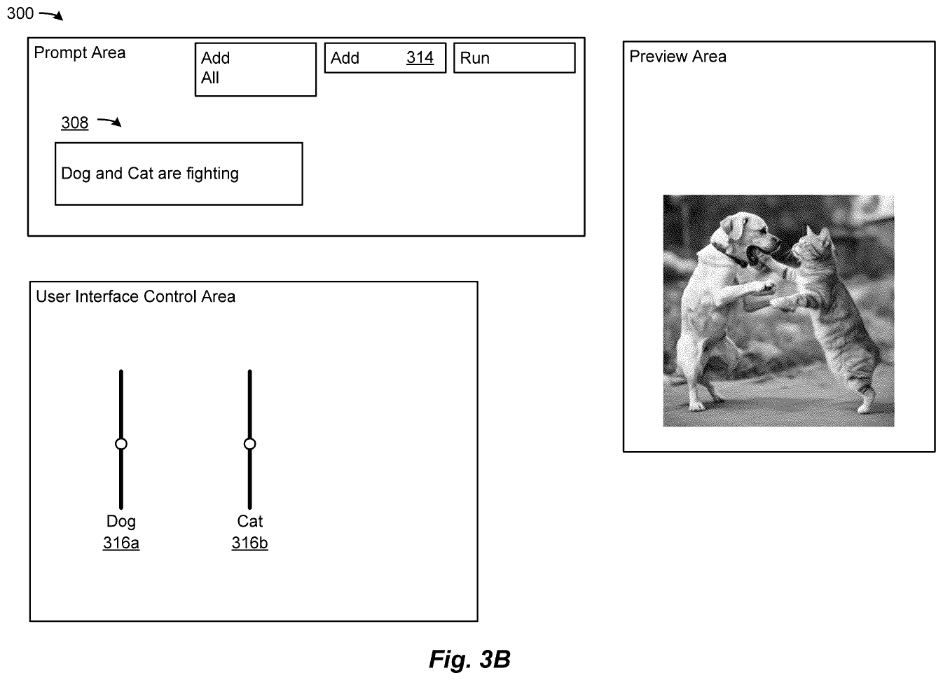

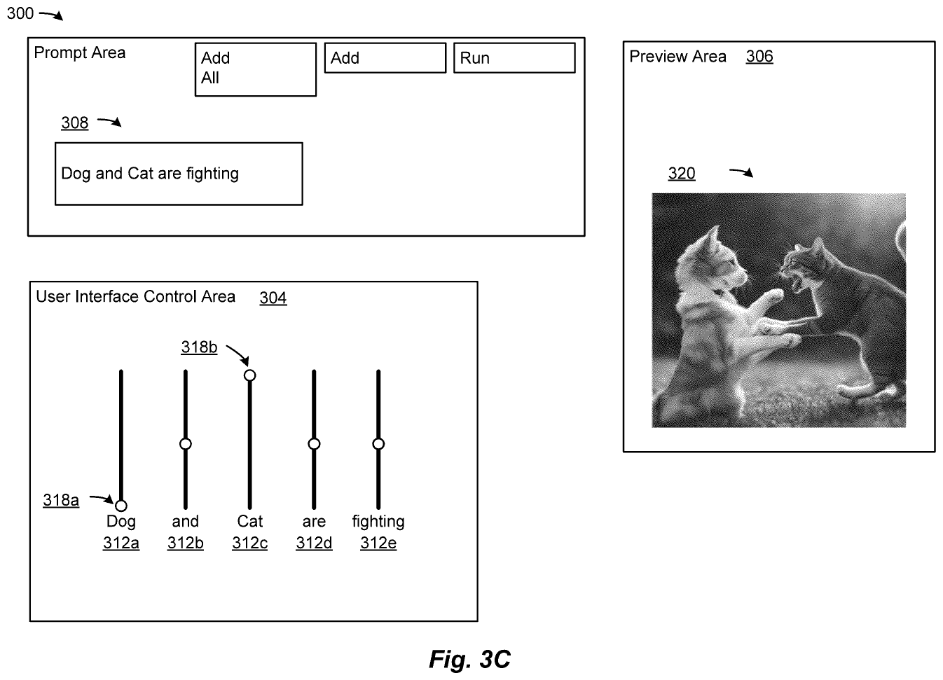

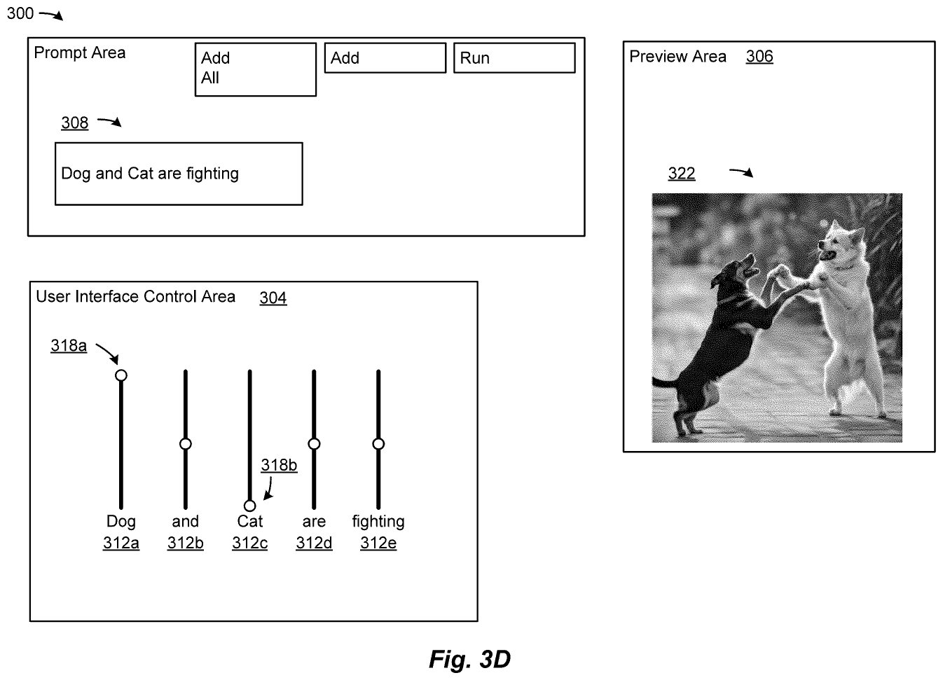

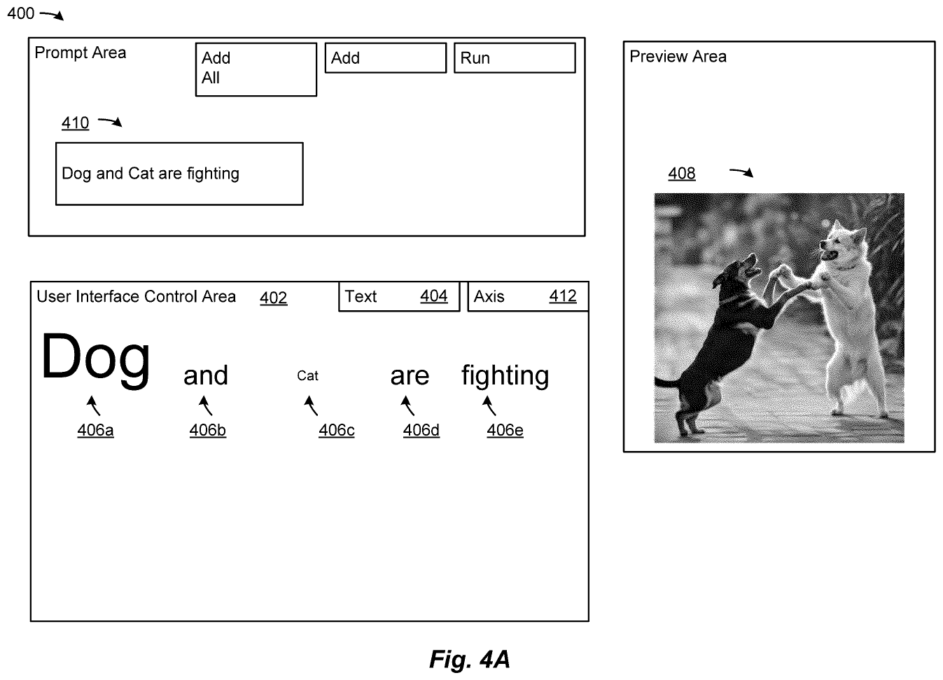

FIGS. 3A-3D illustrate examples of user interfaces for automating content creation by a machine learning model according to some embodiments. As seen in the example of FIG. 3A, user interface 300 includes prompt area 302, user interface controls area 304, and a preview area 306. In some embodiments, prompt area 302, user interface controls area 304, preview area 306, and any combination thereof may be initially unpopulated, indicating that a user has yet to interact with the user interface for the first time.

In FIG. 3A, natural language input 308 is entered into prompt area 302 and contains the words “Dog and Cat are fighting.” Prompt area 302 displays natural language input 308 as the user enters the words, as seen in FIG. 3A, thus allowing the user to add, remove, and modify any of the words of natural language input 308 within prompt area 302 in real time.

The user may then interact with button 310a (Add All) to populate user interface controls area 304 with visual representations associated with each of the plurality of words in natural language input 308. In the example of FIG. 3A, visual representations include slider user interface components 312a-312e that are associated with each word in the words “Dog and Cat are fighting.”

In some embodiments, a user may instead select a particular subset of words in the natural language input to associate with visual representations in the user interface control area. For instance, FIG. 3B shows the same user interface and the same natural language input 308, as in FIG. 3A. However, in the example of FIG. 3B, the user has selected (e.g. highlighted, clicked, etc.) “Dog” and “Cat” in the prompt area and then, by interacting with button 314 (Add), populated the user interface control with only two sliders: namely, slider user interface components 316a and 316b. As seen in FIG. 3B, slider user interface components 316a and 316b are sliders associated with each of the selected words, “Dog” and “Cat.” Accordingly, the user may then interact with slider 316a and/or 316b as described herein.

Returning to FIG. 3A, an example configuration for the visual representations is shown for the case of populating user interface controls area 304 using slider user interface components 312a-312e as the visual representations. Specifically, each slider comprises a slider button at a particular position within the corresponding slider. After initially populating user interface controls area 304, in this example, the slider buttons for each of the slider user interface components 312a-312e are set to the initial positions seen in FIG. 3A. In some embodiments, this initial position may be a default configuration for the visual representations. It may be understood that, in some embodiments, other configurations are possible upon initializing user interface 300.

The example of FIG. 3A also shows the user has interacted with button 310b (Run) and, in response, the system populates preview area 306 with output image 314, which is associated with natural language input 308. In this example, the initial positions for slider buttons of slider user interface components 312a-312e instruct the system to generate a prompt exactly as displayed in prompt area 302 comprising the words “Dog and Cat are fighting” and to submit said prompt to the large language machine learning model to produce the output. Accordingly, output image 314 shows a dog and a cat fighting, as is described by the words “Dog and Cat are fighting” of natural language input 308.

In some embodiments, a large language machine learning model may generate one or more images based on an input prompt associated with natural language input (e.g. 308). Such a large language machine learning model may be large language machine learning model 106 seen in FIG. 1. Then, the system may be configured to populate the preview area of the user interface with a preview of the one or more images. In some embodiments, this preview may be a single image generated by the large language model that undergoes processing to be viewable in preview area 306. In some embodiments, the image is a representative example (e.g. image) of the generated content or one or more output images. Further details regarding producing one or more output images by a large language machine learning model are discussed herein. Accordingly, in this example, output image 314 is produced as the preview to populate preview area 306.

In the example of FIG. 3A, the large language machine learning model generated output image 314 as a preview such that characteristics of the preview are equally weighted in the preview. In particular, the initial position for each slider button of slider user interface components 312a-312e is shown in FIG. 3A as being at an equal, center position of the corresponding slider user interface component for each of the words “Dog and Cat are fighting.” Following the user interaction with button 310b, the system is instructed to generate a prompt for the large language machine learning model indicating that each word included in the prompt is to be considered with equal weight when generating the output images. In this example, the center position of the slider user interface components 312a-312e is mapped to a “normal” weight that is understood by the system to mean that the word corresponding to the slider user interface component having the slider button at the center position is included in the generated prompt exactly as it appears in prompt area 302. Then, because the slider button positions seen in this example apply the same “normal” weight to each word of the prompt, the system generates the prompt as “Dog and Cat are fighting” exactly as the words are being displayed in prompt area 302. Then, the large language machine learning model consumes the prompt to generate output image 314 as the preview where, as seen in FIG. 3A, the preview includes a dog fighting with a cat.

The user may inspect the preview populating preview area 306 and adjust aspects of output image 314 by interacting with visual representations of user interface control area 304. By interacting with the visual representations (e.g. 312a-312e), the position of each slider button is configurable by the user to change the weight value mapped to a particular word and, accordingly, emphasize or de-emphasize the corresponding characteristic in the preview. For example, FIG. 3C illustrates the same user interface 300 of FIG. 3A after receiving a user input modifying the configuration of the visual representations seen in FIG. 3A. In this example, the user input is received in user interface control area 304 as the user interacts with user interface 300 to independently change the position of the slider buttons for the various sliders.

FIG. 3C illustrates that the received user input has modified the configuration for the first time in this example. Accordingly, the position of slider button 318a has changed from its initial position, seen in FIG. 3A, to a bottom position, seen in FIG. 3C. This bottom position is one example of an extreme position for the slider button that represents mapping the visual representation 312a to a lower bounding value of a set of numeric values. The same user input has modified the configuration by changing another slider button position, namely slider button 318b, to a top position, which is an example of another extreme position for slider buttons. In this case, the top position represents mapping visual representation 312c to an upper bounding value in the set of numeric values. In this example, the set of numeric values are weight values for corresponding words included in a prompt being submitted by the system to the large language machine learning model that is used to produce the one or more output images. By changing the slider button positions to the extreme bottom and extreme top positions, in this example, the user is instructing the system that the preview must be changed to de-emphasize (i.e. completely remove) “Dog” elements and simultaneously emphasize “Cat” elements seen in the preview. Accordingly, the preview for output image 320 seen in FIG. 3C includes two cats, instead of one cat, as seen in output image 314 of FIG. 3A, but does not include any dogs.

The set of numeric values may be the set of numeric values 130 seen in FIG. 1. In some embodiments, this set of numeric values is a set of discrete integer values ranging from a lower bounding value to an upper bounding value in integer step sizes. When the visual representations are slider user interface components, as in the examples of FIG. 3A-3D, the visual representations (e.g. 312a-312e) are generated such that the extreme positions on the slider are mapped to the extreme bounding values of the numeric values. Additionally, in these examples, the intermediate positions of a slider button (e.g. 318a) are mapped to intermediate values of the numeric set of values. In some embodiments, the number of intermediate values is determined by the range set by the two bounding values of the numeric set of values and the step size and. In some embodiments, the allowed positions for the slider button may be based on the number of values in the numeric set of values and an order of the values in the set of numeric values. For instance, the bottom position for a slider button may correspond to the smallest value in the numeric set of values according to the order of values in the set, the next highest position for a slider button may correspond to the next smallest value in the numeric set of values that differs from the bottom position by an amount determined by the step size, and so on.

These numeric values are then mapped to a set of predefined natural language terms, such as natural language terms 134 seen in FIG. 1. The set of predefined natural language terms includes a variety of natural language terms from different parts of speech. For instance, the set of predefined natural language terms may comprise one or more of a plurality of adjectives and/or a plurality of adverbs. The adjectives and/or adverbs included in the predefined natural language terms are used in combination with words of the natural language input to generate a prompt for the large language machine learning model. Features and advantages of predefining the set of natural language terms include generating the prompt for the large language machine learning model such that the prompt includes terms that cause the model to generate content based on the natural language input and the visual representations in a predictable manner.

In some embodiments, the plurality of adjectives and/or adverbs included in the set are predefined based on the large language machine learning model that is chosen to generate content. For instance, the one or more output images produced by the large language machine learning model chosen in the example of FIG. 3C may include images emphasizing cats when the word “Cat” is prefixed with the adjectives and adverbs “very many/very strong” in the prompt that is consumed by the chosen model. Such emphasis may include increasing the frequency with which cats appear in the images, as in the preview for output image 320 showing two cats instead of one cat, as seen in output image 314 of FIG. 3A. Alternatively, or in combination therewith, emphasis may include increasing the apparent size of cats that appear in the image. However, the same chosen large language machine learning model may not generate images emphasizing those same aspects (e.g. apparent size, frequency of cats) when using a different set of adjectives and/or adverbs, such as “a lot of.” In some embodiments, a determination of which natural language terms to predefine may be made according to an API and associated documentation associated with the chosen large language machine learning model. As another example, the set of predefined natural language terms may include “small” and “less” because the chosen large language machine learning model generates content containing one or more elements that appear smaller and/or less frequently when the prompt includes one or more of these terms as prefixes for the words describing the one or more elements.

As another example, the large language machine learning model chosen for the example of FIG. 3C may be a weight-based model (e.g. Midjourney). In this context, a weight-based model may be configured to consume prompts that include special text strings comprising characters and numerals in the prompt that indicate emphasis and de-emphasis of various aspects. For example, the set of text characters “::+1” may be understood by the weight-based model as expressing “strong” or as assigning an importance for an element of the prompt. Accordingly, the system described herein may be configured to preprocess the mappings to the set of predefined natural language terms into this special set of characters and include the special set of characters in the generated prompt, prior to sending the prompt to the weight-based large language machine learning model for consumption. Features and advantages of this approach enhance compatibility of the system by allowing the generated content to be associated with the natural language input and the configuration of visual representations independent of the choice of large language machine learning model to generate the content.

As may be understood from FIG. 3A and FIG. 3C, the user input has caused the configuration of visual representations to change because the position of the slider buttons shown in FIG. 3C is different from the initial configuration shown in FIG. 3A. In response to receiving changes to the configuration seen in FIG. 3A, the corresponding numeric values also change. For example, the initial configuration of visual representations 312a-312e in FIG. 3A indicates that each visual representation is mapped to the same intermediate numeric value of “0” in the set of numeric values. After user input changes the configuration to the configuration of FIG. 3C, the one or more mappings to numeric values are also changed based on the configuration. Specifically, the numeric value mapped to slider user interface component 312a changes from “0” to an extreme numeric value of “−2.” Similarly, the numeric value mapped to slider user interface component 312b correspondingly changes from “0” to an extreme numeric value of “+2.”

In some embodiments, the user may move the slider button to the bottom position to indicate that the associated word should be completely removed from the output image, whereas the top position indicates the associated word should be emphasized in the output image, appear more frequently in the output, appear larger in the output, or any combination thereof. For instance, the configuration shown in FIG. 3C indicates that the “Dog” element should be removed from the output image because the corresponding slider button (e.g. 318a) is at the bottom position, whereas the “Cat” element should appear more frequently because the corresponding slider button (e.g. 318b) is at the top position. Accordingly, output image 320 is produced from the large language machine learning model as a preview such that dogs are removed from the image and two cats are shown. The contents of output image 320 appearing in the preview is in contrast to the preview for output image 314 in FIG. 3A, where one cat and one dog appears in the output image.

In this example, the large language machine learning model generates output image 320 based on the received prompt in addition to a received negative prompt coupled to the prompt. Specifically, the system generates the negative prompt based on the configuration of the corresponding slider in FIG. 3C. This negative prompt serves to prevent the appearance of generated content elements associated with one or more words of the negative prompt. In the instant example, in response to the user moving slider button 318a of slider 312a that is associated with the word “Dog,” to the bottom position, the system generates the negative prompt: “Dog.” In some embodiments, each of the prompt and the negative prompt may be coupled with an identifier, indicating a type for each prompt, in a structured text format. For example, the following structured text format may be used to identify each of the prompt and the negative prompt when sending the prompt and negative prompt to the large language machine learning model:
Final Modified Prompt: and very strong Cat are fighting
Final Negative Prompt: Dog

In the above example, “Final Modified Prompt” is the identifier indicating that “and very strong Cat are fighting” is the prompt, whereas “Final Negative Prompt” is an identifier indicating that “Dog” is the negative prompt.

In some embodiments, the user may inspect the generated content in the preview area of the user interface and decide that further modification of the same content is necessary. FIG. 3D follows from FIG. 3C to illustrate an example where the user has received output image 320 of FIG. 3C as a preview and decided that further modifications of the generated content are necessary.

In response to receiving output image 320, the user provides another input modifying the configuration of the visual representations in the user interface for a second time. This second user input changes the configuration of slider buttons for the same slider user interface components 312a-312e seen in FIG. 3C to the configuration of slider button positions shown in FIG. 3D. Then, the configuration seen in FIG. 3D is mapped to a set of numeric values by changing corresponding numeric values based on the latest received user input and the configuration of the visual representations. Specifically, since slider button 318a is in the top position in FIG. 3D, the numeric value it is mapped to changes from “−2” (as in FIG. 3C) to “+2.” Similarly, the mapping for slider button 318b will also change. In this example, the mapping changes from “+2” (as in FIG. 3C) to “−2.” Then the updated set of numeric values is mapped to a corresponding set of predefined natural language terms.

The predefined set of natural language terms resulting from the second user input are used to update the prompt that was generated before receiving the second user input. For instance, in FIG. 3A natural language input 308 contains the words “Dog and Cat are fighting.” The configuration of visual representations seen in FIG. 3C causes the system to generate a basis for the prompt utilizing the all the words of “Dog and Cat are fighting” as follows:
“Dog and Cat are fighting”

Next, the configuration of visual representations seen in FIG. 3C causes the system to generate the following prompt:
“and very many/very strong Cat are fighting”

For the purposes of explanation in this example, the generated prompt shown immediately above is stylized as follows:
“______ and very many/very strong Cat are fighting” (1)

In the stylization of the above example, underscores are used to indicate where one or more words have been removed from the basis for the prompt, seen above, and italics are used to emphasize the one or more words that are being added to the basis for the prompt at the current stage of the prompt generation process. Specifically, underscores of stylized prompt (1) show where the word “Dog,” as seen in the basis for the prompt, has been removed by the system to generate the prompt in accordance with the configuration of the visual representations. The words “very many/very strong” are stylized with italics in stylized prompt (1) to distinguish them as the predefined natural language terms being added to the basis for the prompt. In some embodiments, the generated prompt may have no such styling and, instead, the system may generate stylized prompt (1) as:
“and very many/very strong Cat are fighting”

For the purposes of explanation in this example, however, the prompts have been stylized as discussed above.

After receiving the second user input and performing the necessary mappings, as in FIG. 3D, the prompt at the current stage of prompt generation is updated by the system. The updated prompt may be stylized as follows:
“very many/very strong Dog and ______ are fighting” (2)

Stylized prompt (2) follows from stylized prompt (1). Specifically, stylized prompt (2) shows that “very many/very strong Dog” are the words being added to stylized prompt (1) and that “Cat” is being removed from stylized prompt (1). As such, the updated prompt that is generated by the system that corresponds to stylized prompt (2) is as follows:
“very many/very strong Dog and are fighting”

As may be understood from the above example, the basis of the generated prompt at each stage is natural language input 308 and modifications, updates, and the like are applied to the prompt based on the predefined natural language terms that are generated from the configuration of visual representations.

The updated prompt is then sent to the large language machine learning model, along with any coupled negative prompts, and one or more new output images are generated by the model, as discussed herein. In the example of FIG. 3D, the large language machine learning model produces new output image 322 according to the updated prompt and user interface 300 is updated with an updated preview corresponding to new output image 322 by replacing the preview corresponding to output image 320 with the updated preview. In this example, new output image 322 is associated with natural language input 308 and based on the configuration of visual representations 312a-312e of FIG. 3D. Specifically, the configuration of visual representations 312a-312e indicate that “Dog” should be emphasized in new output image 322 and that “Cat” should be completely removed. As such, new output image 322 shows two dogs fighting, but does not include any cats.

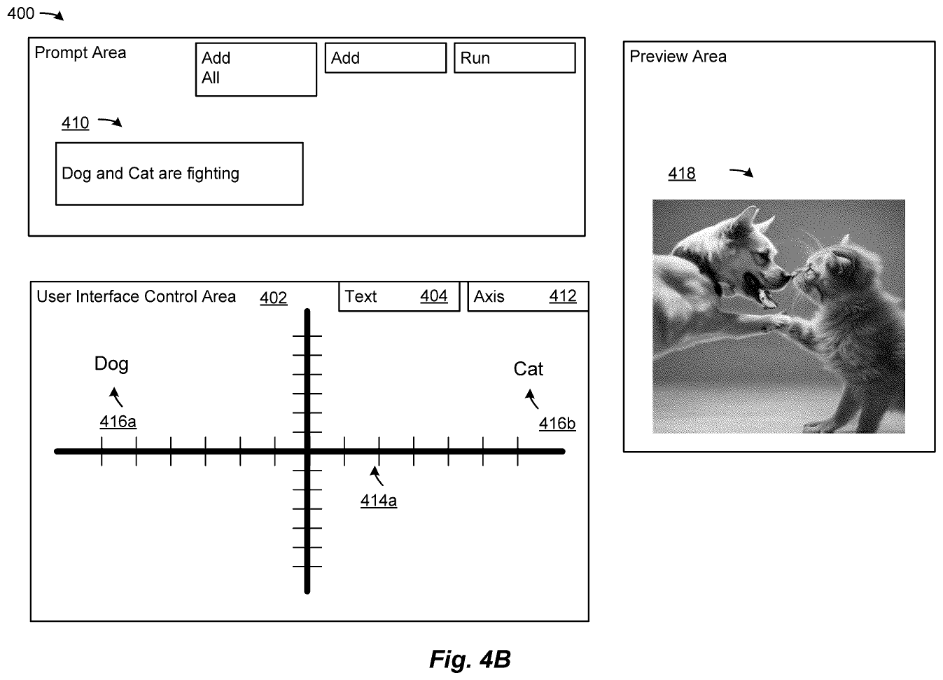

In some embodiments, visual representations may include visual representations of the plurality of words displayed in the user interface having associated font sizes. For example, FIG. 4A shows an example of an alternative user interface 400 where user interface control area 402 is populated by visual representations of the words in “Dog and Cat are fighting” using different font sizes instead of sliders, as in FIGS. 3A-3D. In this example, the user interacts with button 404 (Text) to populate user interface control area 402 with such visual representations. Each visual representation of visual representations 406a-406e is an associated word from “Dog and Cat are fighting” displayed in user interface control area 402 with a particular font size. Visual representations 406b, 406d, and 406e show an example of a default font size associated with the visual representations upon initially populating user interface control area 402 with visual representations 406a-406e.

The font size is configurable such that a user may interact with each word to independently change its associated font size in user interface controls area 402. For instance, FIG. 4A shows that the font size for visual representation 406a, appearing as the word “Dog,” has been increased from the default size. Furthermore, FIG. 4A shows that the associated font size for visual representation 406c, appearing as the word “Cat,” has been decreased from its default size. In this example, a configuration of visual representations 406a-406e includes the associated font sizes for each word appearing in user interface control area 402. Changes to the font sizes change the configuration of the visual representations, and in accordance therewith, change the corresponding mappings from visual representations to numeric values, as described above.

Output image 408 is associated with natural language input 410 through the words of natural language input 410 displayed in the user interface control area. In this example, the configuration of font sizes for visual representations 406a-406e indicate that “Dog” is emphasized and “Cat” is completely removed from the output image (e.g., the font size for “Cat” may be set to the lowest possible value). As such, in this example, output image 408 shows two dogs fighting, but does not include any cats.

Various embodiments of the present disclosure may use visual representations associated with input words to change a wide range of features and characteristics of an large language machine learning model output. For example, the user may interact with button 412 (Axis), as seen in FIG. 4A, to toggle a set of axes 414 in user interface 400, as shown in FIG. 4B. In this example, each quadrant of the set of axes 414 has corresponding parts of speech in the set of predefined natural language terms that describe spatial information for elements appearing in the generated content. For example, the first quadrant is associated with the prepositional terms “in the upper right corner of the picture” and the second quadrant is associated with “in the upper left corner of the picture.”

In some embodiments, the large language machine learning model may be configured to generate content with the elements randomly distributed by default. In the example of FIG. 4B, the user moves visual representation 416a to the second quadrant and visual representation 416b to the first quadrant. In response, the prompt generated by the system for the large language machine learning model is “Dog in the upper left corner of the picture and Cat in the upper right corner of the picture are fighting,” resulting in an output image that matches the described scenario. FIG. 4B illustrates that visual representations associated with natural language inputs may be used to modify prompts to a large language machine learning model to produce a wide range of effects of an output image. Accordingly, the examples provided herein are merely illustrative.

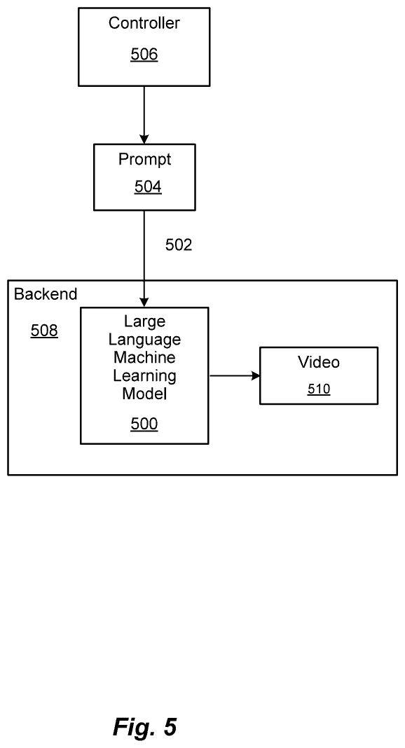

FIG. 5 illustrates an example process for producing output by a machine learning model according to an embodiment. In particular, FIG. 5 shows that large language machine learning model 500 receives 502 a prompt 504 from controller 506. In this example, large language machine learning model 500 is hosted on a backend server 508, which may be the backend 104 of FIG. 1. Backend server 508 exposes an API endpoint that is accessible to controller 506. Namely, after prompt 504 is generated by controller 506, the controller accesses the API endpoint and sends prompt 504 as an API call to backend server 508. In turn, the prompt is consumed by large language machine learning model 500 and one or more output images are generated. In this example, the one or more output images comprises a video based on the prompt where the video comprises a plurality of images presented in a continuous sequence. In some embodiments, video may be transmitted as differences between sequential images such that a subsequent image of the sequential images may be generated from a previous image of the sequential images for the plurality of images in the continuous sequence. Accordingly, the example of FIG. 5 shows large language machine learning model 500 producing one or more output images as video 510 and transmitting the video to controller 506, as described herein.

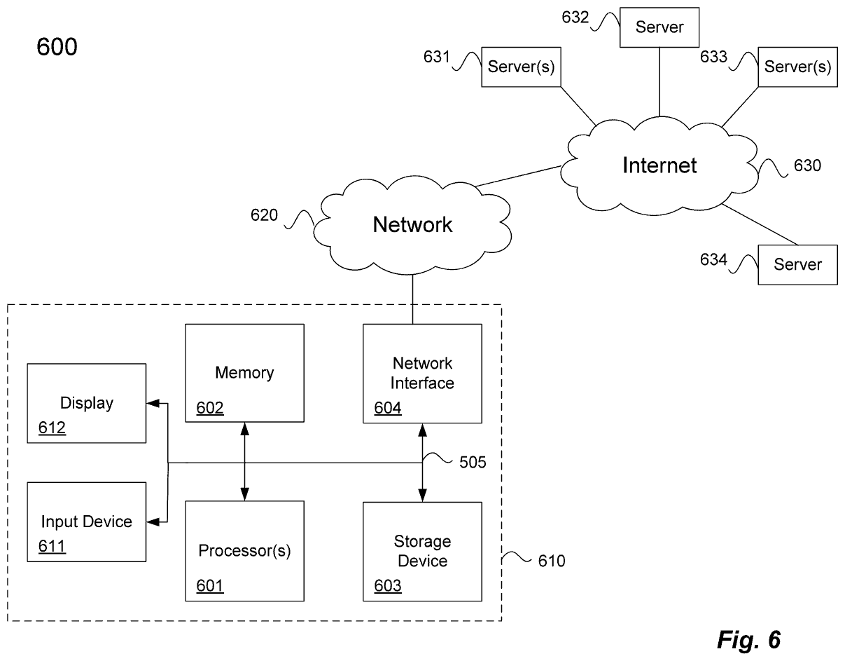

FIG. 6 illustrates hardware of a special purpose computing system 600 configured according to the above disclosure. The following hardware description is merely one example. It is to be understood that a variety of computers topologies may be used to implement the above-described techniques. An example computer system 610 is illustrated in FIG. 6. Computer system 610 includes a bus 605 or other communication mechanism for communicating information, and one or more processor(s) 601 coupled with bus 605 for processing information. Computer system 610 also includes memory 602 coupled to bus 605 for storing information and instructions to be executed by processor 601, including information and instructions for performing some of the techniques described above, for example. Memory 602 may also be used for storing programs executed by processor(s) 601. Possible implementations of memory 602 may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 603 may include source code, binary code, or software files for performing the techniques above, for example. Storage device 603 and memory 602 are both examples of non-transitory computer readable storage mediums (aka, storage media).

In some systems, computer system 610 may be coupled via bus 605 to a display 612 for displaying information to a computer user. An input device 611 such as a keyboard, touchscreen, and/or mouse is coupled to bus 605 for communicating information and command selections from the user to processor 601. The combination of these components allows the user to communicate with the system. In some systems, bus 605 represents multiple specialized buses for coupling various components of the computer together, for example.

Computer system 610 also includes a network interface 604 coupled with bus 605. Network interface 604 may provide two-way data communication between computer system 610 and a local network 620. Network 620 may represent one or multiple networking technologies, such as Ethernet, local wireless networks (e.g., WiFi), or cellular networks, for example. The network interface 604 may be a wireless or wired connection, for example. Computer system 610 can send and receive information through the network interface 604 across a wired or wireless local area network, an Intranet, or a cellular network to the Internet 630, for example. In some embodiments, a frontend (e.g., a browser), for example, may access data and features on backend software systems that may reside on multiple different hardware servers on-prem 631 or across the network 630 (e.g., an Extranet or the Internet) on servers 632-634. One or more of servers 632-634 may also reside in a cloud computing environment, for example.

### FURTHER EXAMPLES

Embodiments of the present disclosure include techniques for content controls to interactively manipulate content specifications to obtain previews and final versions of content.

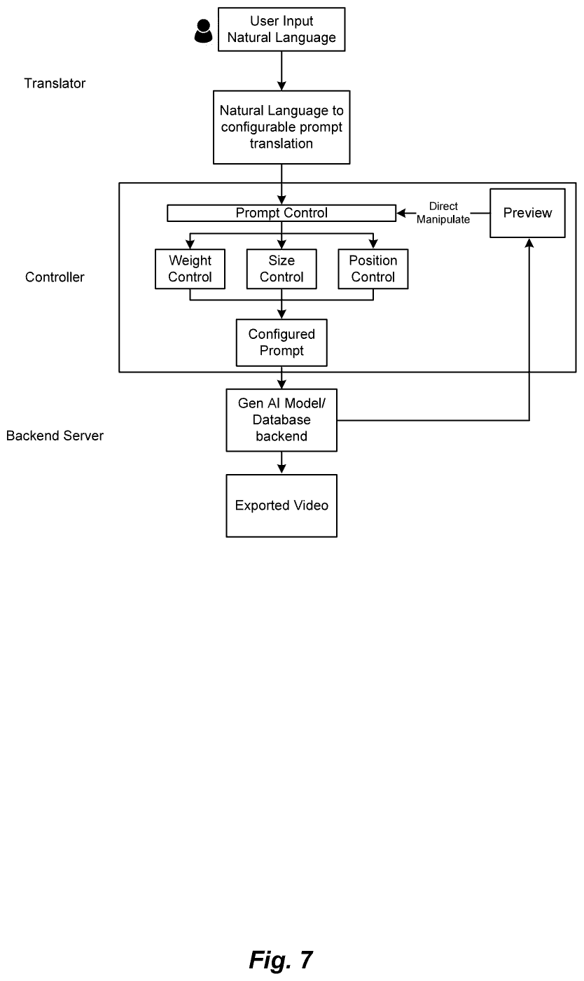

FIG. 7 illustrates a system for controlling content generation according to an embodiment. As shown, a user may input a specification of content to be generated. In some example embodiments, the content to be generated may be an image or a video. A user may enter a text description of the content. In this example, a user enters a natural language speech input, which may be converted to text to configure an input prompt. It is to be understood that a variety of user interfaces may be used to receive the user input. The input prompt may receive text from the user. The text may be a specification of the content to be generated (e.g., “A businessman is entering an office”). The specification of content may comprise a plurality of content elements, which may be words. In this example, a prompt controller software component executing on a computer may associate a plurality of the content elements with attribute values. A user may be presented with a plurality of content controls, and the content controls changing the attribute values associated with the content elements. In this example, content controls may include weight controls, size controls, and positions controls associated with the content specification. In various embodiments, the content controls may include direct manipulation with an image control box, manipulation of font size, direct manipulation by moving keywords in the UI, manipulation by changing font color, 3D manipulation, manipulation using a scroll bar, or manipulation by color control, for example. Manipulation according to these techniques allows a user to change the attribute values associated with a content specification, and thereby modify the content returned to the user. The computer system receives, from the user, an adjustment of one or more of the content controls, and in accordance therewith, adjusts the attribute values associated with the content specification. Next, computer code is generated for accessing content in a content platform. Execution of the computer code returns content based on the specification of content, the plurality of content elements, and the plurality of attribute values adjusted by the user. In this example, an input prompt is configured with the appropriate technical computer code for retrieving content specified by the user, where the elements of the content are adjusted based on the user adjusted attribute values through the user interface.

In various embodiments, a backend database may be used to store images or video. The backend database may comprise previews of the images or videos. Previews are typically smaller digital files that are faster to retrieve and present to a user. A preview may be a lower resolution image or the first frame (or first few seconds of frames) of a video. The computer may automatically generate code to retrieve or generate (e.g., using an AI engine) preview images or video and present the preview to a user for revision, for example. A user may receive a preview, adjust the content controls, and quickly see new preview images or video. Accordingly, a creative user can manipulate aspects of the images freely using the content controls, which are automatically translated into adjusted attribute values to retrieve or generate new preview images or video, which the creative user can continue to manipulate to achieve a desired result. For example, content controls may be used to create a new image/video using a generative AI model. After a user modifies the content controls, the system may receive another new prompt (code) and then create the preview again. A retrieve method may be used to once enough graphic assets are generated and when we want to look for specific images or videos, for example.

Once the content specification and content control settings are set by a user, which satisfy the user's creative goals, final code may be generated in a configured prompt, and used as an input to a database or generative artificial intelligence model, for example, to obtain a final image or video. The final image or video may be a high resolution image or a full video. In this example, the final video is exported to the user.

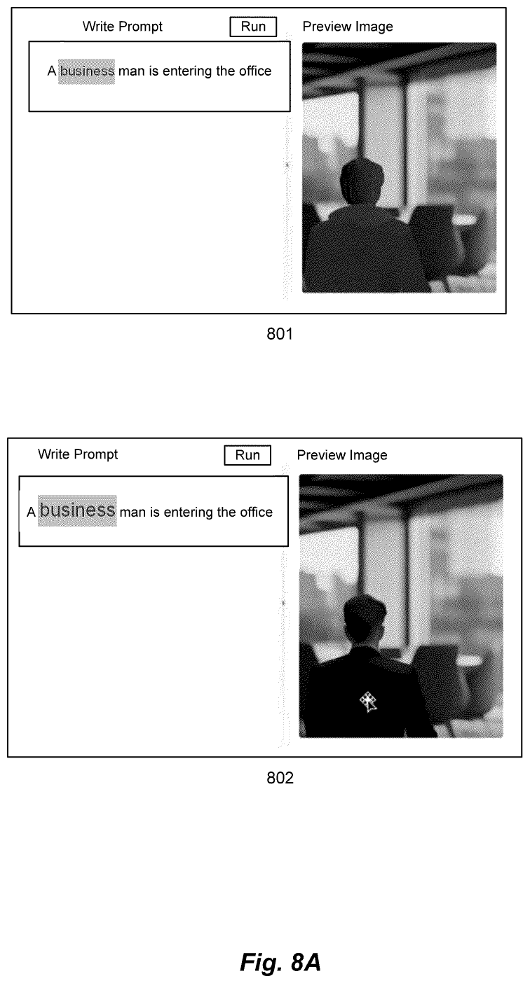

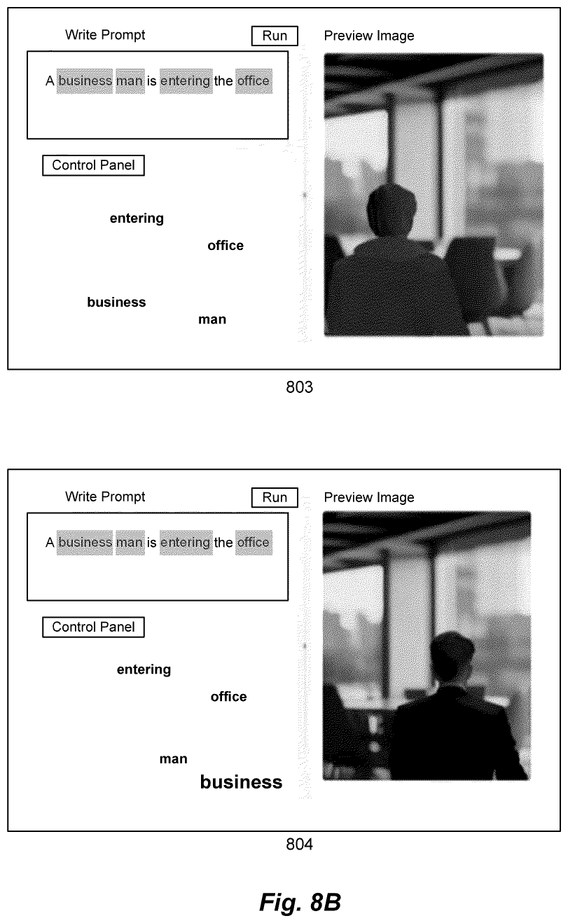

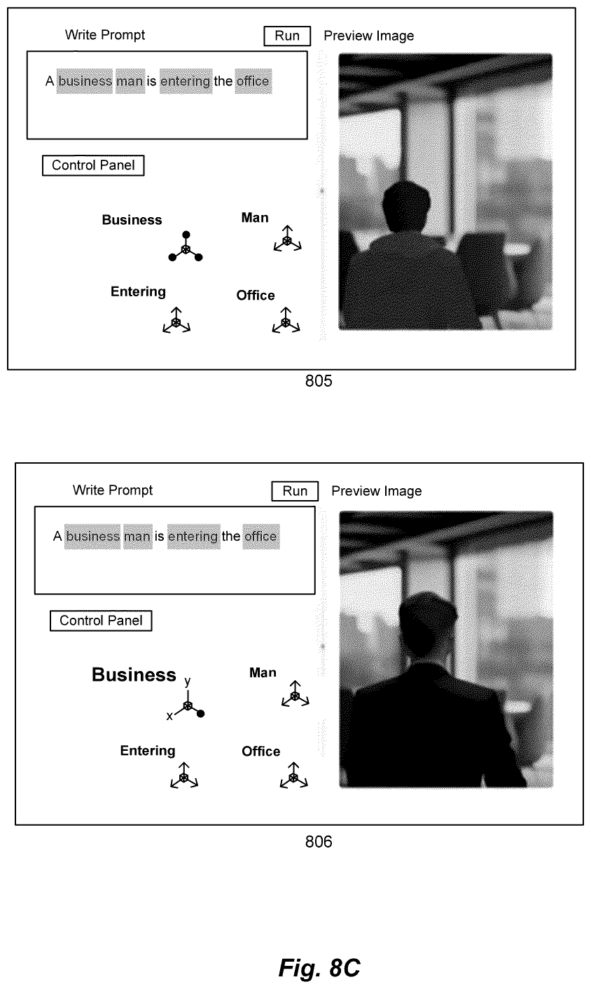

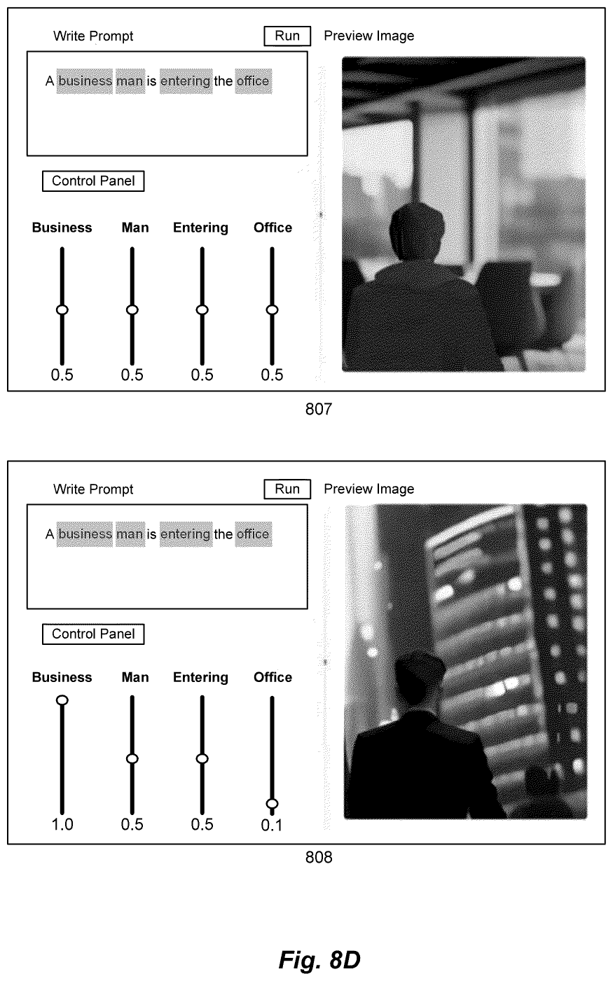

FIGS. 8A-D illustrate example content generation controller techniques according to various embodiments. This example illustrates a user interface (UI) where a user may enter a content specification and adjust attribute values associated with content elements of the specification. In this example, the user enters “A business man is entering the office.” The UI may apply attribute values to the words “business,” “man,” “entering,” and “office.” In this example, the font size may represent different attribute values. At 801, the font sizes are the same, so the attribute values may be the same. Accordingly, the system may generate code with equal attribute values to generate or re-create the image shown in 801. The image in this case shows a man entering a conference room of an office. However, if the user wants to emphasize that the man entering the office is a businessman, the user may increase the font size of the word “business.” For example, the user may increase the word “business” weight, and accordingly, the font size of the word increases to give the user a direct indicator of the attribute value. Accordingly, the code generated may have an increased attribute value associated with “business,” as illustrated at 802, and return another image showing a man in a business suit entering the conference room. This is an example of how font size may be used as a content generation control to change the underlying code generated and used to generate images.

FIG. 8B illustrates another content control technique where the relative positions of the words in the UI alter the attribute values. In this example, a user enters the text “A business man is entering the office. Content elements may be displayed spatially as illustrated at 803. An initial spatial arrangement may produce uniform attribute values as in 801. However, at 804, the word “business” is increased in size and moved to a new position to increase the attribute value associated with this content element. Accordingly, a new image is retrieved and displayed at 204.

FIG. 8C illustrates another content control technique where the elements are associated with coordinates in a 3D space in the UI to alter the attribute values. In this example, a user enters the text “A business man is entering the office.” Content elements are each associated with a 3 dimensional space. Initially, at 805, the 3D positions of the content elements are assigned the same values, which returns the same result as in 801. However, a user may manipulate each content element in a 3-space, thereby changing the attribute values and the results returned are as shown at 804. At 806, business has been adjusted in a 3-space, and hence the image returned is as in 802. For example, 3D manipulation of words may represent the multi-dimensional attributes control. Thus, a wideness, a height, and a thickness of a word may represent three different attributes, which may influence the final image generated in different ways.

FIG. 8D illustrates another content control technique where the elements are associated with coordinates in sliders in the UI to alter the attribute values. In this example, a user enters the text “A business man is entering the office.” Content elements are each associated with each word and a user may adjust attributes using sliders. At 807, the sliders are all set to medium positions. Thus, the result is uniform at in 801. However, at 808, the sliders may be adjusted to increase some content element attribute values and decrease other content element attribute values. In this example, “business” is increased and “office” is decreased. Accordingly, the image shows a man in a business suit with a commercial office building in the background, but not an office conference room.

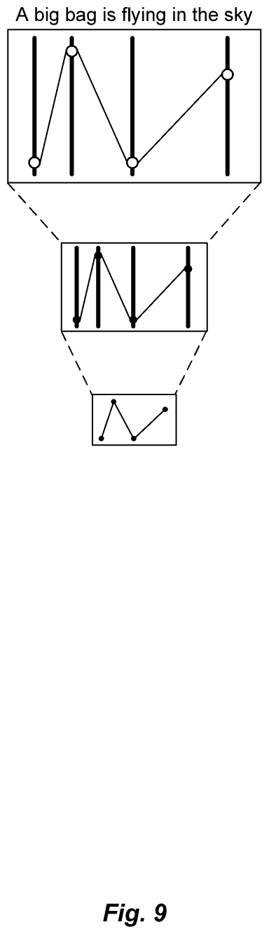

FIG. 9 illustrates another content control technique where the elements are associated with curve to alter the attribute values. In this example, a user enters the content specification as text (e.g., “A big bag is flying in the sky”). Content elements are each associated with a value along a range illustrated by bars as shown. The value associated with each word may increase or decrease an attribute value associated with each word, for example. Embodiments of the disclosure include associating a curve with a content specification. Different shapes of the curve may correspond to different attribute value adjustments of a content specification. The curve may be stored in association with a particular content specification or project, for example, and used to generate computer code to retrieve images, video, or other content corresponding to the curve.

From the above examples, it can be seen that a wide variety of content controls may be provided to a user to manipulate the images or video retrieved by the system.

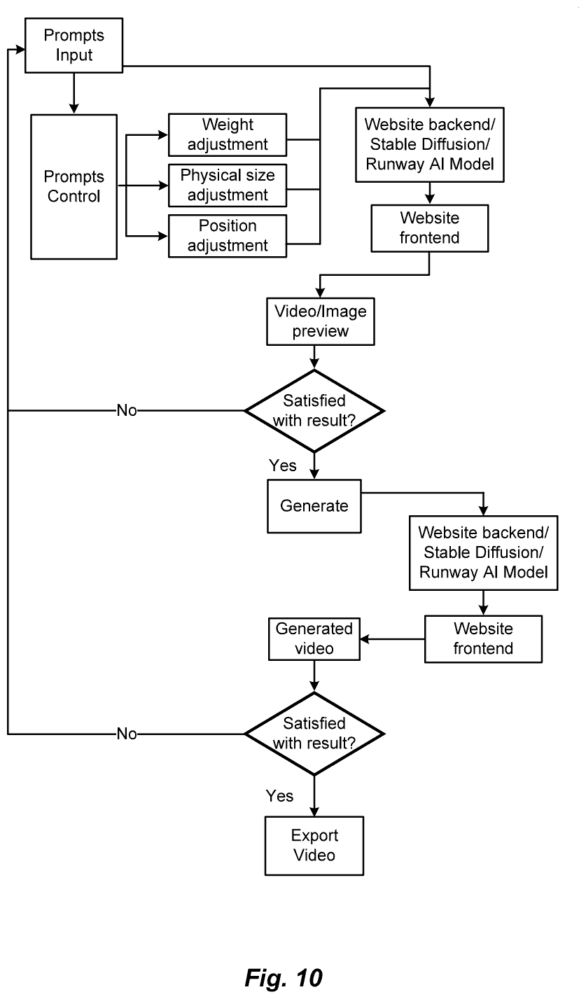

FIG. 10 illustrates an example content generation method according to an embodiment. The system may be implemented as software executing on one or more computer systems comprising one or more processors and memory (DRAM and/or persistent storage drives). Initially, the system prompts a user for input. Content controls may be displayed by a UI, and a user may enter a content specification and control settings. Prompt controls may do a weight adjustment, physical size adjustment, or position adjustment, for example. Code is generated to retrieve the desired content. Example code generated may be as follows:
// get an image of a wooden teapot where wood and teapot of equally weighted
wood::teapot
// get an image of a wooden teapot where wood has a higher weight than teapot
wood::1 teapot::2
// get an image of a wooden teapot where wood and teapot of equally weighted
wood::4 teapot::1
// get a 3D image of a stormtrooper with high realism
Studio Ghibli anime, stormtrooper::1 3d, render, realistic::−0.2
// get a 3D image of a stormtrooper with low realism
Studio Ghibli anime, stormtrooper::1 3d, render, realistic::−1

Generated code is sent to a backend. Preview images are returned to the frontend for display to the user. If the user is not satisfied, the content controls may be further adjusted to achieve the creative results desired by the user. If the user is satisfied, the code is set to the backend and images or video may be created using an AI image or video generator, for example. In this example, video is generated. If the user is not satisfied, the creative process can be repeated to obtain previews and final versions that satisfy the user. When the user is satisfied, the content (e.g., final video) may be exported for use.

### OTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

In one embodiment, the present disclosure includes a system comprising: one or more processors; a non-transitory computer-readable medium storing a program executable by the one or more processors, the program comprising sets of instructions for performing a method.

In another embodiment, the present disclosure includes a non-transitory computer readable medium storing a program executable by at least one processing unit of a device, the program comprising sets of instructions for performing a method.

In one embodiment, the present disclose includes a method.

In various embodiments, the method comprises: receiving a first natural language input comprising a plurality of words; associating the plurality of words with a plurality of controls in a user interface, the plurality of controls comprising visual representations in the user interface corresponding to the plurality of words, wherein the visual representations are configurable in the user interface; receiving a first user input modifying a configuration of the visual representations; in response to receiving the first user input, mapping the visual representations to a first set of numeric values, wherein each value of the first set of numeric values is based on the configuration of the visual representations, and wherein changes to the configuration of the visual representations change corresponding numeric values; mapping each numeric value of the first set of numeric values to a first set of predefined natural language terms; generating a prompt based on the first set of predefined natural language terms; sending the prompt to a large language machine learning model; and producing, by the large language machine learning model, one or more output images.

In one embodiment, the visual representations comprise a slider user interface component associated with each word in the plurality of words, wherein different positions of each slider in the slider user interface components change the configuration of the visual representations, and in accordance therewith, change the corresponding numeric values.

In one embodiment, the visual representations comprise, for each word in the plurality of words, visual representations of the plurality of words in the user interface having associated font sizes, wherein the font sizes are configurable in the user interface, and wherein changes to the font sizes change the configuration of the visual representations, and in accordance therewith, change the corresponding numeric values.

In one embodiment, producing the one or more output images comprises generating, in the user interface, a preview, wherein the preview is based on the one or more output images and associated with the first natural language input being displayed in the user interface.

In one embodiment, the method further comprising: receiving, from the large language machine learning model, the one or more output images as the preview; in response to receiving the preview, receiving a second user input modifying the configuration of the visual representations in the user interface; mapping the configuration to a second set of numeric values by changing corresponding numeric values of the first set of numeric values based on the second user input and the configuration of the visual representations; mapping each numeric value of the second set of numeric values to a second set of predefined natural language terms; updating the prompt based on the second set of predefined natural language terms; sending the prompt to the large language machine learning model; producing, by the large language machine learning model, one or more new output images; and updating the user interface with an updated preview corresponding to the one or more new output images by replacing the preview corresponding to the one or more output images with the updated preview in the user interface.

In one embodiment, the first set of predefined natural language terms comprise one or more of a plurality of adjectives and/or a plurality of adverbs.

In one embodiment, the plurality of adjectives and/or the plurality of adverbs are predefined based on the large language machine learning model.

In one embodiment, the one or more output images comprises a video and wherein the large language machine learning model is configured to produce the video based on the prompt.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A system comprising:
one or more processors;
a non-transitory computer-readable medium storing a program executable by the one or more processors, the program comprising sets of instructions for:
receiving a first natural language input comprising a plurality of words;
associating the plurality of words with a plurality of controls in a user interface, the plurality of controls comprising visual representations in the user interface corresponding to the plurality of words, wherein the visual representations are configurable in the user interface;
receiving a first user input modifying a configuration of the visual representations;
in response to receiving the first user input, mapping the visual representations to a first set of numeric values, wherein each value of the first set of numeric values is based on the configuration of the visual representations, and wherein changes to the configuration of the visual representations change corresponding numeric values;
mapping each numeric value of the first set of numeric values to a first set of predefined natural language terms;
generating a prompt based on the first set of predefined natural language terms;
sending the prompt to a large language machine learning model; and
producing, by the large language machine learning model, one or more output images.

2. The system of claim 1, wherein the visual representations comprise a slider user interface component associated with each word in the plurality of words, wherein different positions of each slider in the slider user interface components change the configuration of the visual representations, and in accordance therewith, change the corresponding numeric values.

3. The system of claim 1, wherein the visual representations comprise, for each word in the plurality of words, visual representations of the plurality of words in the user interface having associated font sizes, wherein the font sizes are configurable in the user interface, and wherein changes to the font sizes change the configuration of the visual representations, and in accordance therewith, change the corresponding numeric values.

4. The system of claim 1, wherein producing the one or more output images comprises generating, in the user interface, a preview, wherein the preview is based on the one or more output images and associated with the first natural language input being displayed in the user interface.

5. The system of claim 4 further comprising:
receiving, from the large language machine learning model, the one or more output images as the preview;
in response to receiving the preview, receiving a second user input modifying the configuration of the visual representations in the user interface;
mapping the configuration to a second set of numeric values by changing corresponding numeric values of the first set of numeric values based on the second user input and the configuration of the visual representations;
mapping each numeric value of the second set of numeric values to a second set of predefined natural language terms;
updating the prompt based on the second set of predefined natural language terms;
sending the prompt to the large language machine learning model;
producing, by the large language machine learning model, one or more new output images; and
updating the user interface with an updated preview corresponding to the one or more new output images by replacing the preview corresponding to the one or more output images with the updated preview in the user interface.

6. The system of claim 1, wherein the first set of predefined natural language terms comprise one or more of a plurality of adjectives and/or a plurality of adverbs.

7. The system of claim 6, wherein the plurality of adjectives and/or the plurality of adverbs are predefined based on the large language machine learning model.

8. The system of claim 1, wherein the one or more output images comprises a video and wherein the large language machine learning model is configured to produce the video based on the prompt.

9. A method comprising:
receiving a first natural language input comprising a plurality of words;
associating the plurality of words with a plurality of controls in a user interface, the plurality of controls comprising visual representations in the user interface corresponding to the plurality of words, wherein the visual representations are configurable in the user interface;
receiving a first user input modifying a configuration of the visual representations;
in response to receiving the first user input, mapping the visual representations to a first set of numeric values, wherein each value of the first set of numeric values is based on the configuration of the visual representations, and wherein changes to the configuration of the visual representations change corresponding numeric values;
mapping each numeric value of the first set of numeric values to a first set of predefined natural language terms;
generating a prompt based on the first set of predefined natural language terms;
sending the prompt to a large language machine learning model; and
producing, by the large language machine learning model, one or more output images.

10. The method of claim 9, wherein the visual representations comprise a slider user interface component associated with each word in the plurality of words, wherein different positions of each slider in the slider user interface components change the configuration of the visual representations, and in accordance therewith, change the corresponding numeric values.

11. The method of claim 9, wherein the visual representations comprise, for each word in the plurality of words, visual representations of the plurality of words in the user interface having associated font sizes, wherein the font sizes are configurable in the user interface, and wherein changes to the font sizes change the configuration of the visual representations, and in accordance therewith, change the corresponding numeric values.

12. The method of claim 9, wherein producing the one or more output images comprises generating, in the user interface, a preview, wherein the preview is based on the one or more output images and associated with the first natural language input being displayed in the user interface, and wherein the method further comprises:
receiving, from the large language machine learning model, the one or more output images as the preview;
in response to receiving the preview, receiving a second user input modifying the configuration of the visual representations in the user interface;
mapping the configuration to a second set of numeric values by changing corresponding numeric values of the first set of numeric values based on the second user input and the configuration of the visual representations;
mapping each numeric value of the second set of numeric values to a second set of predefined natural language terms;
updating the prompt based on the second set of predefined natural language terms;
sending the prompt to the large language machine learning model;
producing, by the large language machine learning model, one or more new output images; and
updating the user interface with an updated preview corresponding to the one or more new output images by replacing the preview corresponding to the one or more output images with the updated preview in the user interface.

13. The method of claim 9, wherein the first set of predefined natural language terms comprise one or more of a plurality of adjectives and/or a plurality of adverbs, and wherein the plurality of adjectives and/or the plurality of adverbs are predefined based on the large language machine learning model.

14. The method of claim 9, wherein the one or more output images comprises a video and wherein the large language machine learning model is configured to produce the video based on the prompt.

15. A non-transitory computer readable medium storing a program executable by at least one processing unit of a device, the program comprising sets of instructions for:
receiving a first natural language input comprising a plurality of words;
associating the plurality of words with a plurality of controls in a user interface, the plurality of controls comprising visual representations in the user interface corresponding to the plurality of words, wherein the visual representations are configurable in the user interface;
receiving a first user input modifying a configuration of the visual representations;
in response to receiving the first user input, mapping the visual representations to a first set of numeric values, wherein each value of the first set of numeric values is based on the configuration of the visual representations, and wherein changes to the configuration of the visual representations change corresponding numeric values;
mapping each numeric value of the first set of numeric values to a first set of predefined natural language terms;
generating a prompt based on the first set of predefined natural language terms;
sending the prompt to a large language machine learning model; and
producing, by the large language machine learning model, one or more output images.

16. The non-transitory computer readable medium of claim 15, wherein the visual representations comprise a slider user interface component associated with each word in the plurality of words, wherein different positions of each slider in the slider user interface components change the configuration of the visual representations, and in accordance therewith, change the corresponding numeric values.

17. The non-transitory computer readable medium of claim 15, wherein the visual representations comprise, for each word in the plurality of words, visual representations of the plurality of words in the user interface having associated font sizes, wherein the font sizes are configurable in the user interface, and wherein changes to the font sizes change the configuration of the visual representations, and in accordance therewith, change the corresponding numeric values.

18. The non-transitory computer readable medium of claim 15, wherein producing the one or more output images comprises generating, in the user interface, a preview, wherein the preview is based on the one or more output images and associated with the first natural language input being displayed in the user interface, and wherein the program further comprises instructions for:
receiving, from the large language machine learning model, the one or more output images as the preview;
in response to receiving the preview, receiving a second user input modifying the configuration of the visual representations in the user interface;
mapping the configuration to a second set of numeric values by changing corresponding numeric values of the first set of numeric values based on the second user input and the configuration of the visual representations;
mapping each numeric value of the second set of numeric values to a second set of predefined natural language terms;
updating the prompt based on the second set of predefined natural language terms;
sending the prompt to the large language machine learning model;
producing, by the large language machine learning model, one or more new output images; and
updating the user interface with an updated preview corresponding to the one or more new output images by replacing the preview corresponding to the one or more output images with the updated preview in the user interface.

19. The non-transitory computer readable medium of claim 15, wherein the first set of predefined natural language terms comprise one or more of a plurality of adjectives and/or a plurality of adverbs, and wherein the plurality of adjectives and/or the plurality of adverbs are predefined based on the large language machine learning model.

20. The non-transitory computer readable medium of claim 15, wherein the one or more output images comprises a video and wherein the large language machine learning model is configured to produce the video based on the prompt.
